(19) United States
(12) Patent Application Publication
(10) Pub. No.: US 2011/0029911 A1
(43) Pub. Date: Feb. 3, 2011

(54) Method for Configuring an Actuation System

(75) Inventor: Jonathan R. Schroeder, Machesney Park, IL (US)

Correspondence Address: REINHART BOERNER VAN DEUREN P.C., 2215 PERRYGREEN WAY, ROCKFORD, IL, 61107, US

(73) Assignee: PACIFIC BEARING COMPANY, Rockford, IL (US)

(21) Appl. No.: 12/846,538

(22) Filed: Jul. 29, 2010

Related U.S. Application Data
(60) Provisional application No. 61/230,166, filed on Jul. 31, 2009.

(51) Int. Cl. G06F 3/048

(52) U.S. Cl. 715/771; 715/810

(57) ABSTRACT

A method of configuring a linear actuation system that includes establishing a connection via an electronic communication network with a linear actuation system customer, and receiving data that includes customer requirements for a linear actuation system, the data transmitted over the communication network. The method also includes presenting the customer with a series of options, based on the customer requirements, to select components for the linear actuation system, and displaying a scaled representation of the linear actuation system with those components selected by the customer.

### CROSS-REFERENCE TO RELATED PATENT APPLICATIONS

This patent application claims the benefit of U.S. Provisional Patent Application No. 61/230,166, filed Jul. 31, 2009, the entire teachings and disclosure of which are incorporated herein by reference thereto.

### FIELD OF THE INVENTION

This invention generally relates to single-axis and multi-axis actuation systems, and specifically to methods for configuring such systems.

### BACKGROUND OF THE INVENTION

Single-axis and multi-axis linear motion systems are commonly used in industrial settings. These motion systems range from very simple rod actuator systems to complex three-axis pick and place robotic systems capable of performing many operations in less than one second. The end users of these systems have a great number of options in terms of the components which make up the system. A variety of linear guidance mechanisms, propulsion systems, motors, controllers, gear boxes, sensors, cable carriers, and other accessories are available. However, choosing the best components in terms of price, performance, reliability and durability can be a formidable task, even for experienced engineers.

For example, when a user, or more accurately at this point a customer, needs to purchase an actuation system for the transport and manipulation of one or more workpieces, the customer typically goes to a seller of actuators to select one or more appropriate actuators for the system. Generally, the customer would then go to a seller of motors to select one or more motors along with suitable controllers for the system. Further, the customer might also have to deal with various makers of accessories, such as sensors, mounting feet, shock absorbers, cable carriers, gear boxes, motor mount couplings, in order to select the appropriate accessories for the actuation system.

This method of configuring an actuation system is time consuming, and also poses the risk that some of the components selected by the customer will not be compatible, thus requiring the customer to repeat parts of the process until a workable system is assembled. It would not be unusual that the first time an engineer/designer (with a basic understanding of motion) designs a linear motion system, for that engineer to spend more than half a week researching all of the different components and technologies and trying to find combinations which will work together. It would therefore be desirable to have a method which allows for customers to purchase all of the components of an actuation system at one time, such that the purchasing process is completed quickly, and where there is no risk of selecting incompatible components.

Embodiments of the invention provide such a method for the configuration of actuation systems. These and other advantages of the invention, as well as additional inventive features, will be apparent from the description of the invention provided herein.

### BRIEF SUMMARY OF THE INVENTION

In one aspect, embodiments of the invention provide a method of configuring a linear actuation system that includes establishing a connection via an electronic communication network with a linear actuation system customer, and receiving data that includes customer requirements for a linear actuation system, the data transmitted over the communication network. The method also includes presenting the customer with a series of options, based on the customer requirements, from which to select components for the linear actuation system, and displaying a scaled representation of the linear actuation system including those components selected by the customer.

In a particular embodiment, the method of configuring a linear actuation system includes configuring a linear actuation system that is a multi-axis linear actuation system.

In another embodiment, the method of configuring a linear actuation system further includes receiving data from the customer via the communication network, the data including information related to the desired shape of the linear actuation system.

A particular embodiment provides a method of configuring a linear actuation system, wherein presenting the customer with a series of options, based on the customer requirements, from which to select components for the linear actuation system comprises presenting the customer with a list of actuators that satisfy the customer requirements.

A more particular embodiment provides a method of configuring a linear actuation system, wherein presenting the customer with a series of options, based on the customer requirements, from which to select components for the linear actuation system comprises presenting the customer with a list of suitable actuator accessories.

An even more particular embodiment provides a method of configuring a linear actuation system, wherein presenting the customer with a series of options, based on the customer requirements, from which to select components for the linear actuation system comprises presenting the customer with a list of suitable motors.

Yet, an even more particular embodiment provides a method of configuring a linear actuation system, wherein presenting the customer with a series of options, based on the customer requirements, from which to select components for the linear actuation system comprises presenting the customer with a list of suitable peripheral accessories.

One embodiment provides a method of configuring a linear actuation system, wherein displaying a scaled representation of the linear actuation system comprises displaying one of engineering drawings and 3D models.

In one particular embodiment, a method of configuring a linear actuation system further includes generating at least one of technical specifications, bills of material, and cost quotes for the fully-configured linear actuation system.

In another aspect, embodiments of the invention provide a method of constructing a linear actuation system that includes configuring a server to receive data transmitted from a customer over an electronic communication network, wherein the data includes customer system requirements for a linear actuation system that is adapted to transport and manipulate one or more workpieces, and using the data transmitted by the customer to generate a suitable list of components from which the customer can construct the linear actuation system, then transmitting the suitable list of components to the customer over the communication network. The method further calls for receiving a customer-generated set of selected components via the communications network, and transforming the information received from the customer into a scaled illustration of the fully configured linear actuation system.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flowchart showing the steps for configuring an actuation system according to an embodiment of the invention;

FIG. 2 is a pictorial view of a generic linear actuation system;

FIG. 3 shows the system of FIG. 2 with a customer selected actuator;

FIG. 4 shows the system of FIG. 3 including the actuator accessories chosen by the customer;

FIG. 5 shows the system of FIG. 4 with the customer selected motor and controller;

FIG. 6 shows the system of FIG. 5 with the addition of various customer selected accessories; and

FIG. 7 shows an exemplary pictorial view of a fully configured linear actuation system according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

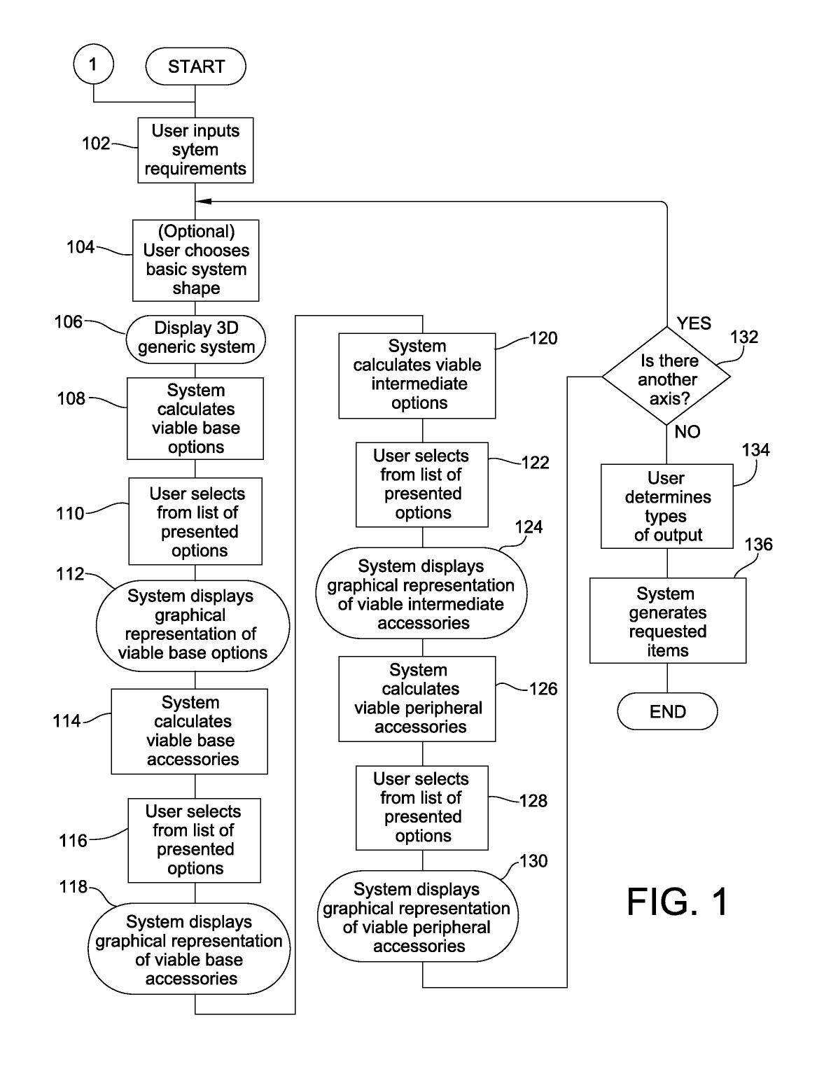

FIG. 1 is a flowchart illustrating the process steps for configuring a single axis or multi-axis linear actuation system according to an embodiment of the invention. The first step 102 calls for the user (e.g., customer) to input the system requirements in terms of the work to be performed by the system once configured. Typically, these system requirements will include a description of the apparatus (i.e., clamps, platforms, magnets, etc.) needed to handle the workpiece or workpieces to be manipulated by the actuation system. This description may also include the weight, physical dimensions and other relevant properties of the aforementioned workpieces, along with some description of how the workpiece is to be manipulated by the actuation system. Further, the user will be able to input parameters such as the maximum allowable system cost, the operating environment in which the system will be used (i.e., ambient temperature, humidity, air quality, available power supply), user's level of expertise, maintenance capabilities, etc.

In an embodiment of the invention, the user, or customer, will also define the coordinate system to be used, and may be asked to define the gravity axis, i.e. that axis which runs parallel to the force of gravity. The user will also have the option of inputting additional parameters, such as any moments to be applied to the workpiece, any limitations on speed of travel or allowable acceleration curves, or, alternatively, time and/or distance requirements for the workpiece to complete a designated route of travel. Other parameters, including dimensional tolerances and workpiece rigidity, can also be input if required.

When desired, the user will be able to input a minimum safety factor for the configured linear actuation system. The safety factor is a ratio of the applied load to the allowable load, thus providing an indication of how safe a linear actuation system is for a particular application. The system designed to handle substantially greater loads then those expected to be applied will have a safety factor significantly lower than one in which the applied loads and the expected load is nearly equal.

It is contemplated that users will input the aforementioned user requirements via an electronic communication network such as the internet, and intranet or some other type of private network. It is also contemplated that the user will typically access the communication network using a PC, PDA, or some other suitable electronic device.

Still referring to FIG. 1, the flowchart shows that the configuration process includes an optional second step 104 in which the user, if there are certain physical plant limitations that have to be met, can input the basic system footprint, or shape, to ensure that the system, when configured, will fit in the space allotted. For example, space limitations may require the user to fit the linear actuation system into a L-shaped or a U-shaped space within the user's plant.

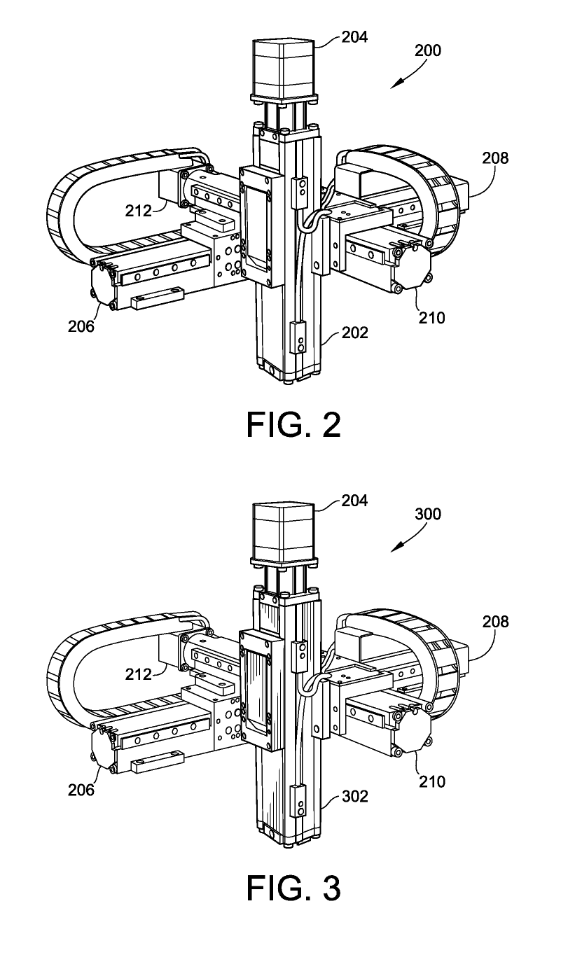

Based on the input gathered from the user thus far, the configuration system is able to present the user with a series of equipment options from which the user can construct the linear actuation system. In a particular embodiment of the invention, in step 106, the system displays a three dimensional (3-D) representation of a generic actuation system including generic representations of various system components. FIG. 2 shows a pictorial view of an exemplary embodiment of such a generic linear actuation system 200. In an embodiment of the invention, FIGS. 2-7 are 3-D representations of the linear actuation systems shown to customers seeking to configure their own linear actuation system. The generic linear actuation system 200 includes actuators for three dimensions, and includes a first generic linear actuator 202, which in this example represents the gravity axis by virtue of its vertical orientation. First generic linear actuator 202 is operated by a first generic motor 204. A second generic actuator 206 is operated by a second generic motor 208, and a third generic actuator 210 is operated by a third generic motor 212. However, an alternate embodiment of the invention may initially shown only a single axis to be configured and add additional axes as called for by the system requirements input by the user, or customer.

In step 108, the configuration system provides the user with a list of base options that satisfy the user input requirements. Typically, this base option relates to the choice of an actuator, for example a linear actuator, for the first axis of the system. An actuator is a mechanical device for moving or controlling a mechanism or system. Typically, actuators convert energy (e.g., electrical energy, hydraulic energy, pneumatic energy) into some form of motion, for example linear motion. Some of the drive types for actuators include belt-driven, ball screw, and lead screw. In industrial-type environments, including some factory settings, a chain and cable or rack and pinion drive system might be used. In an embodiment of the invention, in addition to the list of viable actuator options, the configuration system will allow the user to choose the actuator drive type if a specific drive type is desired. In one embodiment, the configuration system will show the most relevant properties for each actuator drive type including, but not limited to, cost, installation, and maintenance information to better allow the user to make an informed choice. Additionally, an embodiment of the configuration system is adapted to provide a recommended actuator drive type to the user based on information input at step 102, if the user does not have a preference concerning actuator drive type.

The configuration system also offers the user a choice as to the linear guidance system. For example, the actuator may employ a linear recirculating ball system, a cam roller/follower system, a gliding polymer surface or a profile guide linear rail system. As with the drive type, the user will be able to specify a preferred type of linear guidance system, or accept a recommended guidance system based on previous inputs such as selected actuator drive type, along with those inputs entered at step 102.

In step 110, the user makes a selection from the list of viable options presented by the configuration system. Specifically, the user will choose an actuator from the list of viable base options. In step 112, once the selection is made, the configuration system updates the display replacing the generic actuator with the user selected actuator. The display is configured to update the actuation system with each selection made by the user. The display update made in this step 112, will give the user some idea of how the actuator will appear in the actuation system when fully configured. FIG. 3 illustrates a partially generic linear actuation system 300 of FIG. 2 with the addition of the user-selected linear actuator 302. In an embodiment of the invention, generic components are displayed by the configuration system in gray, for example. In this particular embodiment of the invention, when a generic component is replaced by a user-selected component, the user-selected component is displayed in a contrasting color (e.g., blue, red, green, yellow) to make the user-selected components easily distinguishable from the generic components. This is shown in FIGS. 3-7 by shading. Note that none of the components in the generic linear actuation system 200 are shaded. Those user-selected components described below in FIGS. 3-7 are shaded to clearly differentiate between generic components shown by the configuration system and user-selected components which the configuration system has substituted for the generic components shown initially.

Based on user input gathered in step 102, and based on the actuator selected, in step 114 the configuration system generates a list of viable options for accessories to the actuator. In step 116, the user makes a selection from the options presented. In this step 116, the user will typically be able to choose, for example, the type of motor mount coupling used in the actuator system, e.g., an elastomer for a bellows type coupling. Additionally, the user will generally be able to select, for example, a specific type of air bearing, or a specific gear box to be used with the selected actuator.

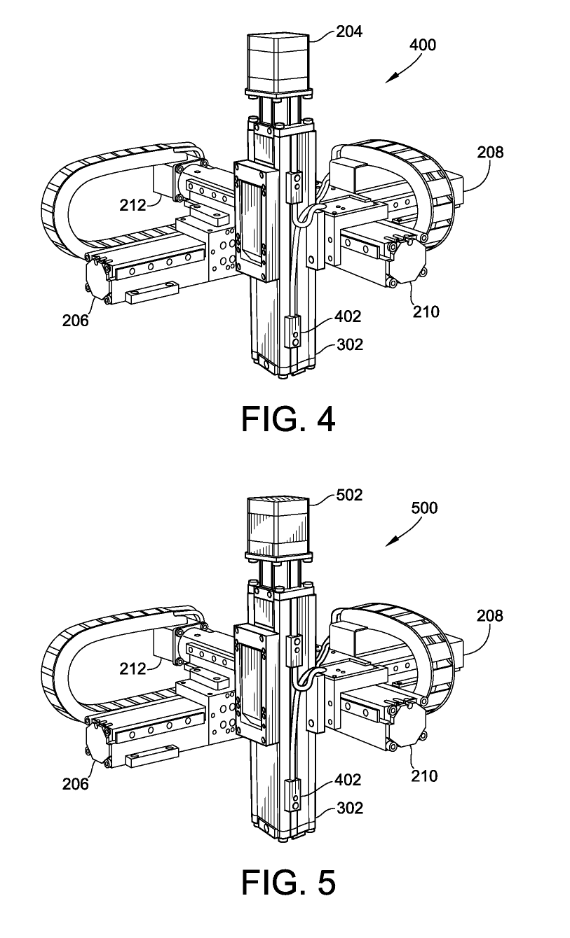

In step 118, the configuration system updates the 3-D display of the actuator system to reflect the user selection of accessories for the actuator. FIG. 4 illustrates the partially generic linear actuation system 400 of FIG. 3 with the addition of a user-selected linear actuator accessory 402. The updated 3-D display of FIG. 4 now shows the partially generic linear actuation system 400 with user-selected linear actuator 302 and an exemplary user-selected linear actuator accessory 402, while other system components, such as actuators 206, 210 and motors 208, 212 are still shown in generic form (i.e., in gray).

In step 120, the configuration system generates a list of options for selecting the motor and motor controller based on user input requirements. In this step 120, the user is able to choose, for example, between a stepper motor and a servo motor. In an embodiment of the invention, the user will also be able to specify the size and desired output of the motor. Further, the configuration system is adapted to provide information on cost, maintenance, along with operation and installation requirements to allow the user to take these factors into consideration when choosing the motor.

If there is more than one controller suitable for the selected motor, the configuration system will allow the user to select the controller by providing relevant information similar to that provided for the motor, i.e., cost, maintenance, installation, utility requirements, user capabilities, etc. However, as described above, the configuration system can recommend a motor and controller based on the initial user input requirements and on the type of actuator selected in step 110.

In step 122, the user selects the motor and controller from the list of viable options presented by the configuration system. In step 124, the configuration system displays the actuation system reflecting the user selections made thus far. FIG. 5 illustrates the linear actuation system 500 of FIG. 4 with the addition of the motor 502 and controller selected by the user, thus providing a 3-D illustration of the partially configured linear actuation system 500.

In step 126, the configuration system presents the user with options for peripheral accessories, which may include, but are not limited to, various sensors, cable carriers, mounting feet, and shock absorbers. In step 128, the user selects the appropriate peripheral accessories. In an embodiment of the invention, if the user has no specific requirements, the configuration system can recommend peripheral accessories based on initial user input and prior selections.

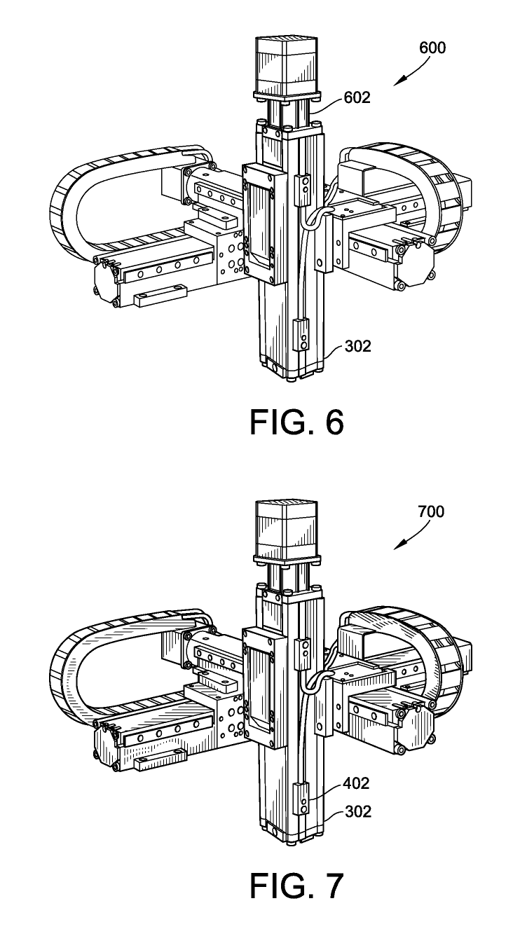

In step 130, the configuration system displays the update 3-D representation of the linear actuation system to include the user selection of peripheral accessories. FIG. 6 illustrates the linear actuation system 600 of FIG. 5 updated to include the user selected peripheral accessories chosen in the previous step 128. FIG. 6 shows the linear actuation system 600 fully configured for one axis including a user-selected motor mount coupling 602.

In step 132, the configuration system determines, based on initial user input, if another axis needs to be configured. If a second axis needs to be configured, the system returns to step 106, where the user is presented with choices for the linear actuator to be used in the second axis of the linear actuation system, and the configuration process is repeated, i.e., steps 106 to 130, until the second axis is fully configured. The 3-D display of the linear actuation system is updated accordingly.

For multi-axis linear actuation system having three axes, the above-described process is repeated for the third axis. As above, at step 132, the configuration system returns to step 106 where the user is presented with actuator options for the third axis. After step 130, in this final iteration, the multi-axis linear actuation system is fully configured. FIG. 7 illustrates an exemplary embodiment of a fully configured 3-D linear actuation system 700. This provides the user with an accurate, scaled depiction of the linear actuation system 700 based on the user's requirements and equipment selections.

When the configuration system reaches step 132 for the third time, it determines that there are no other axes to be configured. In step 134, the configuration system then allows the user to choose the desired outputs. At this step 134, the user may choose to print or save the displayed 3-D representation of the fully configured linear actuation system. The user may also choose to print or save bills of material, cad files, technical specifications, or cost quotes for the fully configured system.

The configuration system as described above allows the user to configure an entire 3-D linear actuation system at one time without the need to contact multiple vendors or the need to deal with issues of compatibility, and providing the user with all of the materials necessary to assemble and purchase the linear actuation system. In step 136, the configuration system provides the user with the materials requested in step 134. As mentioned above, it may take an engineer, designing his first multi-axis linear actuation system more than a week to configure a workable system using conventional methods of contacting multiple vendors and researching the various options available. However, it is contemplated that using an embodiment of the present invention as described herein, that same engineer may configure a complete multi-axis linear actuation system in less than one hour.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of configuring an actuation system comprising:
establishing a connection, via an electronic communication network, with a linear actuation system customer;
receiving data from the linear actuation system customer that includes customer requirements for a linear actuation system, the data transmitted over the electronic communication network;
presenting the customer with a series of options, based on the customer requirements, from which to select components for the linear actuation system; and
displaying a scaled representation of the linear actuation system that includes the components selected by the customer.

2. The method of claim 1, wherein the linear actuation system is a multi-axis linear actuation system.

3. The method of claim 1, further comprising receiving data from the customer via the communication network, the data including information related to the desired shape of the linear actuation system.

4. The method of claim 1, wherein presenting the customer with a series of options, based on the customer requirements, from which to select components for the linear actuation system comprises presenting the customer with a list of actuators that satisfy the customer requirements.

5. The method of claim 4, wherein presenting the customer with a series of options, based on the customer requirements, from which to select components for the linear actuation system comprises presenting the customer with a list of suitable actuator accessories.

6. The method of claim 5, wherein presenting the customer with a series of options, based on the customer requirements, from which to select components for the linear actuation system comprises presenting the customer with a list of suitable motors.

7. The method of claim 6, wherein presenting the customer with a series of options, based on the customer requirements, from which to select components for the linear actuation system comprises presenting the customer with a list of suitable peripheral accessories.

8. The method of claim 1, wherein displaying a scaled representation of the linear actuation system comprises displaying one of engineering drawings and 3D models.

9. The method of claim 1, further comprising generating at least one of technical specifications, bills of material, and cost quotes for the fully-configured linear actuation system.

10. A method of constructing a linear actuation system comprising:
configuring a server to receive data transmitted from a customer over an electronic communication network, wherein the data includes customer system requirements for a linear actuation system that is adapted to transport and manipulate one or more workpieces;
using the data transmitted by the customer to generate a suitable list of components from which the customer can construct the linear actuation system, then transmitting the suitable list of components to the customer over the communication network;
receiving a customer-generated set of selected components via the communications network; and
transforming the information received from the customer into a scaled illustration of the fully configured linear actuation system.

11. The method of claim 10, wherein the linear actuation system is a multi-axis linear actuation system.

12. The method of claim 10, further comprising receiving data from the customer via the communication network, the data including information related to the desired shape of the linear actuation system.

13. The method of claim 10, wherein using the data transmitted by the customer to generate a suitable list of components from which the customer can construct the linear actuation system comprises using the data transmitted by the customer to generate a suitable list of actuators.

14. The method of claim 13, wherein using the data transmitted by the customer to generate a suitable list of components from which the customer can construct the linear actuation system comprises using the data transmitted by the customer to generate a suitable list of actuator accessories.

15. The method of claim 10, wherein using the data transmitted by the customer to generate a suitable list of components from which the customer can construct the linear actuation system comprises using the data transmitted by the customer to generate a suitable list of motors.

16. The method of claim 10, wherein using the data transmitted by the customer to generate a suitable list of components from which the customer can construct the linear actuation system comprises using the data transmitted by the customer to generate a suitable list of peripheral accessories.

17. The method of claim 10, wherein transforming the information received from the customer into a scaled illustration of the fully configured linear actuation system comprises transforming the information received from the customer into 3D computer-aided-design models.

18. The method of claim 10, wherein transforming the information received from the customer into a scaled illustration of the fully configured linear actuation system comprises transforming the information received from the customer into engineering drawings.

19. The method of claim 10, further comprising generating at least one of technical specifications, bills of material, and cost quotes for the fully-configured linear actuation system.
